(19) United States
(12) Patent Application Publication
(10) Pub. No.: US 2012/0061875 A1
(43) Pub. Date: Mar. 15, 2012

(54) TEMPLATE CHUCK, IMPRINT APPARATUS, AND PATTERN FORMING METHOD

(76) Inventor: Takuya KONO, Yokosuka-Shi (JP)

(21) Appl. No.: 13/230,564

(22) Filed: Sep. 12, 2011

(30) Foreign Application Priority Data
Sep. 13, 2010 (JP) 2010-204728

(51) Int. Cl. B29C 59/02

(52) U.S. Cl. 264/293; 425/385

(57) ABSTRACT

In one embodiment, a template chuck for an imprint apparatus includes first and second bodies configured to contact an upper surface and a lower surface of a template, respectively, to sandwich the template vertically. The chuck further includes contact members configured to contact side surfaces of the template to sandwich the template laterally. The chuck further includes a deformation controller configured to deform the template by applying a stress to the template through the contact members. In addition, the first body, the second body, and the contact members are configured to be movable individually.

### CROSS REFERENCE TO RELATED APPLICATION

This application is based upon and claims the benefit of priority from the prior Japanese Patent Application No. 2010-204728, filed on Sep. 13, 2010, the entire contents of which are incorporated herein by reference.

### FIELD

Embodiments described herein relate to a template chuck, an imprint apparatus, and a pattern forming method.

### BACKGROUND

A template chuck of a conventional imprint apparatus includes a template holding unit and a deformation control unit. The template holding unit holds a template standardized to have the same thickness as a photomask for optical lithography, by attracting the template from its upper surface direction. The deformation control unit controls the deformation of the template by applying a stress to the template from its side surface direction.

However, the template chuck of the conventional imprint apparatus has a problem that the template holding performance and deformation control performance are deteriorated when the thickness, material, or shape of the template is changed.

### BRIEF DESCRIPTION OF THE DRAWINGS

FIG. 1 is a side sectional view showing a structure of a nanoimprint apparatus of a first embodiment;

FIG. 2 is a side sectional view showing a structure of a template chuck of the first embodiment;

FIG. 3 is an enlarged side sectional view of the template chuck of FIG. 2;

FIG. 4 is an enlarged top view of the template chuck of FIG. 2;

FIG. 5 is a top view showing the structure of the template chuck of FIG. 2;

FIGS. 6A and 6B are top views for explaining deformation control of a template;

FIG. 7 is a side sectional view schematically showing a sectional shape of the template;

FIG. 8 is a side sectional view showing the template on which a pressure from pins is applied;

FIGS. 9A, 9B, 9C, and 9D are top views and side sectional views showing a second body whose pins move vertically and laterally;

FIG. 10 is a side sectional view showing a structure of a template chuck of a second embodiment;

FIG. 11 is an enlarged side sectional view of the template chuck of FIG. 10;

FIGS. 12A and 12B are top views showing examples of a shape of a recess of the template shown in FIG. 10;

FIG. 13 is a side sectional view showing a structure of a template chuck of a third embodiment; and

FIG. 14 is an enlarged side sectional view of the template chuck of FIG. 13.

### DETAILED DESCRIPTION

Embodiments will now be explained with reference to the accompanying drawings.

An embodiment described herein is a template chuck for an imprint apparatus, the chuck including first and second bodies configured to contact an upper surface and a lower surface of a template, respectively, to sandwich the template vertically. The chuck further includes contact members configured to contact side surfaces of the template to sandwich the template laterally. The chuck further includes a deformation controller configured to deform the template by applying a stress to the template through the contact members. In addition, the first body, the second body, and the contact members are configured to be movable individually.

Another embodiment described herein is an imprint apparatus including first and second bodies configured to contact an upper surface and a lower surface of a template, respectively, to sandwich the template vertically. The apparatus further includes contact members configured to contact side surfaces of the template to sandwich the template laterally. The apparatus further includes a deformation controller configured to deform the template by applying a stress to the template through the contact members. The apparatus further includes a light source configured to irradiate a resist material on a transfer target substrate with light while the template is in contact with the resist material, to cure the resist material. In addition, the first body, the second body, and the contact members are configured to be movable individually.

Another embodiment described herein is a pattern forming method including bringing first and second bodies into contact with an upper surface and a lower surface of a template, respectively, to sandwich the template vertically between the first and second bodies. The method further includes bringing contact members into contact with side surfaces of the template to sandwich the template laterally between the contact members. The method further includes deforming the template by applying a stress to the template through the contact members. The method further includes curing a resist material on a transfer target substrate while the template is in contact with the resist material, to form a resist pattern on the transfer target substrate. In addition, the first body, the second body, and the contact members are configured to be movable individually.

### First Embodiment

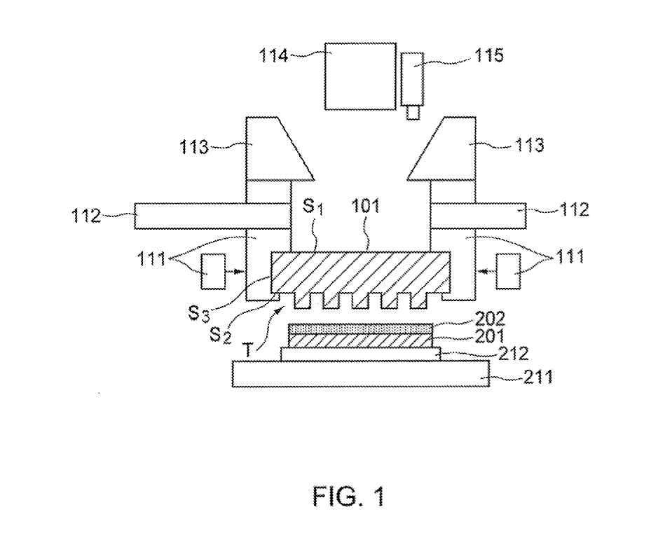

FIG. 1 is a side sectional view showing a structure of a nanoimprint apparatus of a first embodiment.

The nanoimprint apparatus of FIG. 1 includes a template chuck 111, a base 112, an alignment sensor 113, an ultraviolet (UV) light source 114, a charge coupled device (CCD) camera 115, a sample stage 211, and a sample chuck 212.

The template chuck 111 is configured to hold a template 101 and to control deformation of the template 101. The template 101 is set in the template chuck 111 so that a principal surface provided with a concavo-convex pattern T for nanoimprint becomes a lower surface, and the reverse principal surface becomes an upper surface. In FIG. 1, the upper surface, the lower surface, and side surfaces of the template 101 are denoted by S₁, S₂, and S₃, respectively. The template chuck 111 is attached to the base 112 which is located above the template chuck 111.

The sample stage 211 is used to set a transfer target substrate 201 such as a wafer substrate. The transfer target substrate 201 is set on the sample stage 211 so that a principal surface on which a resist material 202 is to be formed is an upper surface, and the reverse principal surface is a lower surface. The transfer target substrate 201 is chucked by the sample chuck 212 so as to be fixed onto the sample stage 211.

Further, the alignment sensor 113 is configured to detect an alignment mark on the template 101. The UV light source 114 is configured to irradiate the resist material 202 on the transfer target substrate 201 with UV light to cure the resist material 202. The nanoimprint apparatus of FIG. 1 irradiates the resist material 202 with the UV light while the template 101 is in contact with the resist material 202, to cure the resist material 202. As a result, a resist pattern is formed on the transfer target substrate 201. Further, the CCD camera 115 is configured to monitor the template 101.

The template 101 of the present embodiment is formed of a transparent member such as quartz for enabling the detection of the alignment mark, the irradiation of the transfer target substrate 201 with the UV light, and the monitoring of the template 101.

Hereinafter, a structure of the template chuck 111 will be described in detail.

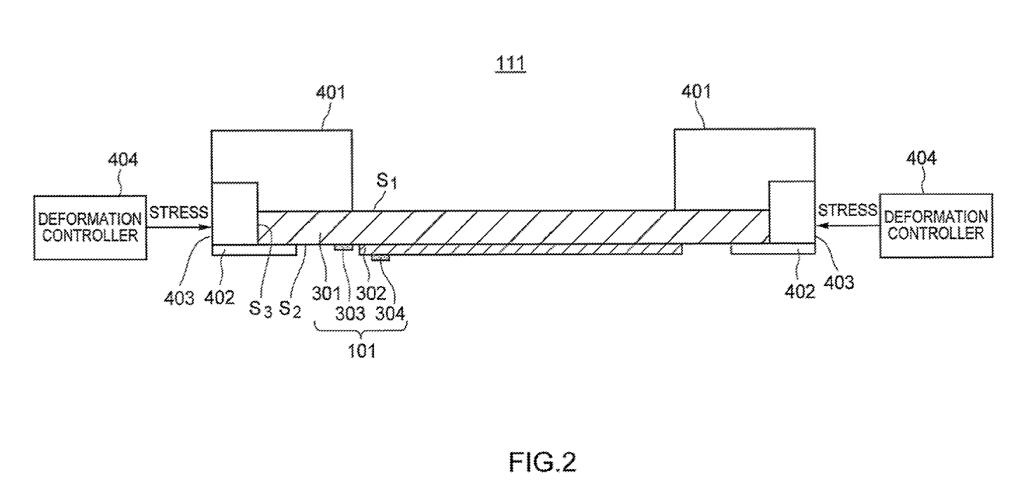

FIG. 2 is a side sectional view showing the structure of the template chuck 111 of the first embodiment.

FIG. 2 shows the template 101 which includes a template substrate 301 and a pattern face 302 formed on a principal surface of the template substrate 301, and is set downwardly on the template chuck 111. FIG. 2 further shows an alignment mark 303 provided on the principal surface of the template substrate 301, and an alignment mark 304 provided on the pattern face 302.

As shown in FIG. 2, the template chuck 111 includes a first body 401, a second body 402, a plurality of contact members 403, and a deformation controller 404.

The first and second bodies 401 and 402 are configured to contact the upper surface S₁ and ,the lower surface S₂ of the template 101, respectively, to sandwich the template 101 vertically. The first body 401 is, for example, an electrostatic chuck or a vacuum chuck for attracting the template 101 with an electrostatic force or vacuum. The second body 402 may be formed of any member in the present embodiment.

The contact members 403 are configured to contact the side surfaces S₃ of the template 101 to sandwich the template 101 laterally. In the present embodiment, the template 101 has four side surfaces S₃, and therefore four contact members 403 sandwich the template 101. Among the four contact members 403, FIG. 2 shows two contact members 403 located in front of the first body 401. The number of the contact members 403 is not limited to four.

The deformation controller 404 is configured to deform the template 101 by applying a stress to the template 101 through the contact members 403. The deformation controller 404 is used for distorting the planar shape of the template 101 so that the planar shape matches the distortion of the pattern on the transfer target substrate 201. The stress applied to the template 101 is generated by a piezoelectric device or an actuator included in the deformation controller 404, for example.

In the present embodiment, such template chuck 111 holds the template 101 and controls the deformation of the template 101. Further, the nanoimprint apparatus of FIG. 1 transfers a pattern to the transfer target substrate 201 by using the template 101 held and deformed by such template chuck 111, and the UV light source 114.

Hereinafter, problems of a conventional template chuck and advantages of the template chuck 111 of the present embodiment will be described.

The conventional template chuck includes an electrostatic chuck or a vacuum chuck, and a deformation controller. The electrostatic chuck or vacuum chuck attracts a template from its upper surface direction to hold the template. Further, the deformation controller is brought into contact with side surfaces of the template, to control the deformation of the template by applying a stress directly to the template. In this way, the template is held by the attraction from the upper surface direction and the stress from the side surface direction.

However, the conventional template chuck has a problem that the template holding performance and deformation control performance are deteriorated when the thickness, material, or shape of the template are changed. For example, when the thickness of the template is reduced, the contact areas between the side surfaces of the template and the deformation controller are reduced. As a result, there occur problems that the template becomes difficult to be held, a high-order distortion component is generated in the template by the stress, and the template is damaged, for example. In addition, those problems may be especially obvious in the case where the template is formed of a brittle material, and the size of the template is small.

Conventionally, a template is often fabricated from a photomask, so that the thickness and the material of the template are generally the same as those of the photomask. Moreover, the template is often fabricated by equally dividing the photomask into four parts, so that the template generally has a shape of one part of the divided photomask.

However, in recent years, the template has often been fabricated from a wafer substrate, so that the thickness, material, and shape of the template are often different from the above-described thickness, material, and shape (in general, the template fabricated from the wafer substrate is often thinner than that of the template fabricated from the photomask).

Therefore, if the template holding performance and deformation control performance are deteriorated by changing the thickness, material, or shape of the template as in the conventional template chuck, it is disadvantage for the recent nanoimprinting in many cases.

On the other hand, as shown in FIG. 2, the template chuck 111 of the present embodiment sandwiches the template 101 vertically between the first and second bodies 401 and 402 to hold the template 101. Therefore, in the present embodiment, templates 101 having various thicknesses can be held by changing the distance between the first body 401 and the second body 402.

Moreover, in the present embodiment, the template 101 is supported from underneath by the second body 402. Therefore, even if the stress from the deformation controller 404 and the attraction force from the first body 401 are small, the template 101 can be held. Accordingly, in the present embodiment, a thin template 101 which may be highly-distorted or damaged by a strong stress, a template 101 formed of a brittle material, and a small template 101 can be held while avoiding the high-order distortion and the damage.

As described above, according to the present embodiment, templates 101 having various thicknesses, formed of various materials, and having various shapes can be held.

Further, in the present embodiment, the deformation controller 404 applies the stress to the template 101 through the contact members 403 to control the deformation of the template 101. Specifically, the deformation controller 404 applies the stress to the contact members 403, so that the stress from the contact members 403 is applied to the template 101.

Therefore, in the present embodiment, the function of contacting the side surfaces S₃ of the template 101 is separated from the deformation controller 404. Therefore, the contact members 403 can be configured to be suitable for contacting the side surfaces S₃ of the template 101, and the deformation controller 404 can be configured to be suitable for applying the stress to the template 101.

For example, in the present embodiment, as shown in FIG. 2, the thickness of the contact members 403 is set to be larger than the thickness of the template 101. This makes it possible to make the contact area between the deformation controller 404 and the contact members 403 larger than the contact area between the deformation controller 404 and the template 101 in a case where the deformation controller 404 and the template 101 are directly in contact with each other.

Such structure has the following effect. Namely, by virtue of the fact that the contact area between the deformation controller 404 and the contact members 403 is large, the deformation controller 404 can easily hold the template 101. This makes it possible to enhance the template holding performance of the template chuck 111.

Moreover, according to such structure, the deformation controller 404 can easily apply the stress to the template 101, so that the deformation controller 404 is not required to generate an unnecessarily large force. Consequently, in the present embodiment, the application of an excessive stress to the template 101 and the generation of a high-order distortion component in the template 101 are prevented. This makes it possible to control deformation of templates 101 having various thicknesses, formed of various materials, and having various shapes.

In the present embodiment, the template chuck 111 includes the first body 401, the second body 402, the contact members 403, and the deformation controller 404 as described above, so that the holding and the deformation control of templates 101 having various thicknesses, formed of various materials, and having various shapes can be realized.

Moreover, in the present embodiment, the first body 401, the second body 402, and each of the contact members 403 are configured to be movable individually. According to such structure, the holding and the deformation control of the templates 101 having various thicknesses, formed of various materials, and having various shapes can be easily realized by driving those components individually. In the present embodiment, the first and second bodies 401 and 402 are configured to be movable vertically, and each of the contact members 403 is configured to be movable laterally (horizontally). Particularly, each of the contact members 403 is configured to be movable in direction perpendicular to the facing side surface S₃.

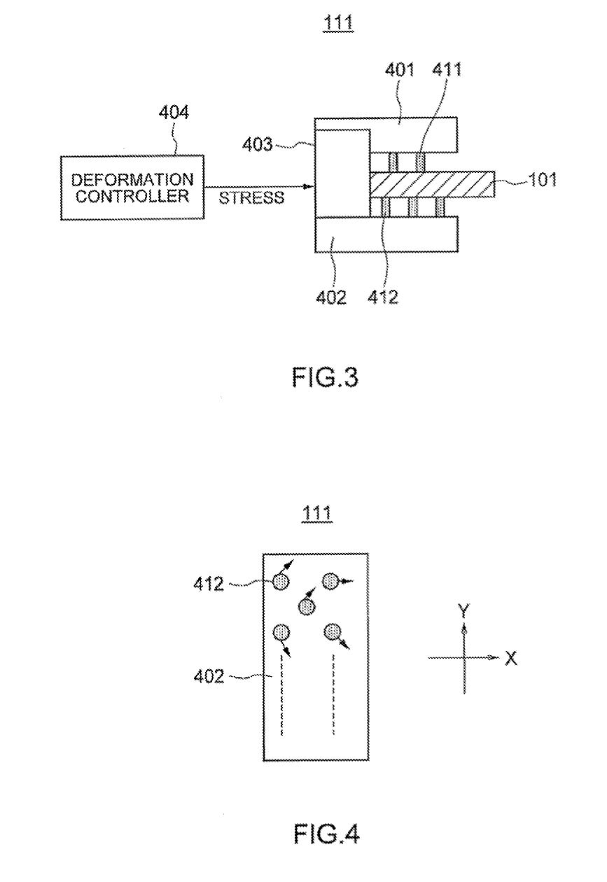

Hereinafter, the structure of the template chuck 111 will be described in more detail with reference to FIGS. 3 to 9.

FIG. 3 is an enlarged side sectional view of the template chuck 111 of FIG. 2.

As shown in FIG. 3, the first body 401 has a plurality of pins 411 on its lower surface. The pins 411 are examples of first pins. Similarly, the second body 402 has a plurality of pins 412 on its upper surface. The pins 412 are examples of second pins. The first and second bodies 401 and 402 are configured to be in contact with the upper surface S₁ and the lower surface S₂ of the template 101 through the pins 411 and 412, respectively.

FIG. 4 is an enlarged top view of the template chuck 111 of FIG. 2.

FIG. 4 shows the second body 402 viewed from above.

Similarly to FIG. 3, FIG. 4 shows the pins 412 provided on the upper surface of the second body 402. The X and Y directions shown in FIG. 4 represent lateral directions perpendicular to each other.

Hereinafter, the functions of the pins 411 and 412 will be described in detail.

In order to distort the shape of the template 101 to match the distortion of the pattern on the transfer target substrate 201 (FIG. 1), a vertical pressure as well as the lateral stress may be required to be applied to the template 101. While the deformation controller 404 has the function of applying the lateral stress to the template 101, the pins 411 and 412 have a function of applying the vertical pressure to the template 101. This is because a pressure from the first and second bodies 401 and 402 concentrates on the pins 411 and 412, so that a large vertical pressure from the pins 411 and 412 are applied to the template 101.

The arrangement of the pins 411 and 412 is not limited to that shown in FIG. 4, and various arrangements other than that shown in FIG. 4 can be used.

In addition, it is preferable that each of the pins 411 and 412 is configured to be movable laterally and vertically. For example, as shown in FIG. 4, it is preferable that the pins 411 and 412 can be moved in an arbitrary direction in an X-Y plane.

The details of the arrangement and the movement of the pins 411 and 412 will be described below.

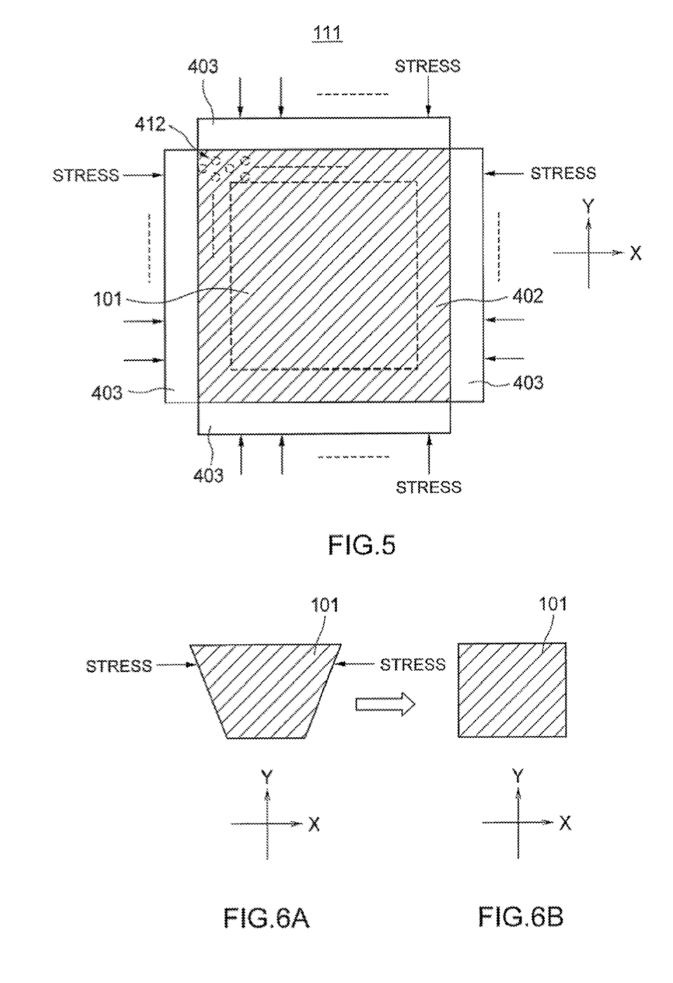

FIG. 5 is a top view showing the structure of the template chuck 111 of FIG. 2.

FIG. 5 shows the template 101, the second body 402 supporting the template 101 from underneath, and the contact members 403 in contact with the template 101 from the sides of the template 101. FIG. 5 further shows the pins 412 provided on the upper surface of the second body 402.

As shown in FIG. 5, the template 101 is subjected to the stress from the four side surface directions of the template 101 through the contact members 403. The template 101 is further subjected to the pressure from the pins 412 in the low& surface direction of the template 101. In the present embodiment, the pins 412 are arranged under the vicinity of the four side surfaces of the template 101.

FIGS. 6A and 6B are top views for explaining the deformation control of the template 101.

FIG. 6A shows a state in which a distortion in an X-Y direction occurs in the template 101. In this case, the stress shown by arrows in FIG. 6A is applied to the template 101, whereby the distortion of the template 101 can be eliminated (FIG. 6B).

When the planar shape of the template 101 needs to be distorted to match the distortion of the pattern on the transfer target substrate 202, the stress is also applied to the template 101, similarly to the case of FIG. 6.

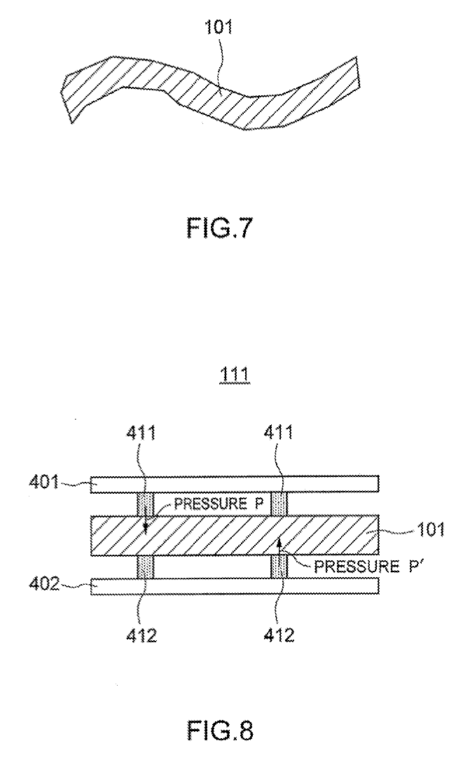

FIG. 7 is a side sectional view schematically showing a sectional shape of the template 101.

FIG. 7 shows a state in which a distortion in a vertical direction occurs in the template 101. The vertical distortion of the template 101 can be eliminated by the pressure from the pins 411 and 412. This will be described with reference to FIG. 8.

FIG. 8 is a side sectional view showing the template 101 on which the pressure from the pins 411 and 412 are applied.

The pins 411 and 412 of the present embodiment are configured to be movable vertically as described above. FIG. 8 shows a state in which the distortion of the template 101 shown in FIG. 7 is eliminated by using the function of the pins 411 and 412. In FIG. 8, the upper left pin 411 applies a downward pressure P to the template 101, and the lower right pin 412 applies an upward pressure P′ to the template 101. As a result, the distortion of the template 101 shown in FIG. 7 is eliminated. The upper right pin 411 and the lower left pin 412 in FIG. 8 protrude such an extent that they merely support the template 101.

As described above, the pins 411 and 412 of the first and second bodies 401 and 402 have an effect of enabling to hold templates 101 having various thicknesses, and an effect of eliminating (or applying) the vertical distortion of the template 101.

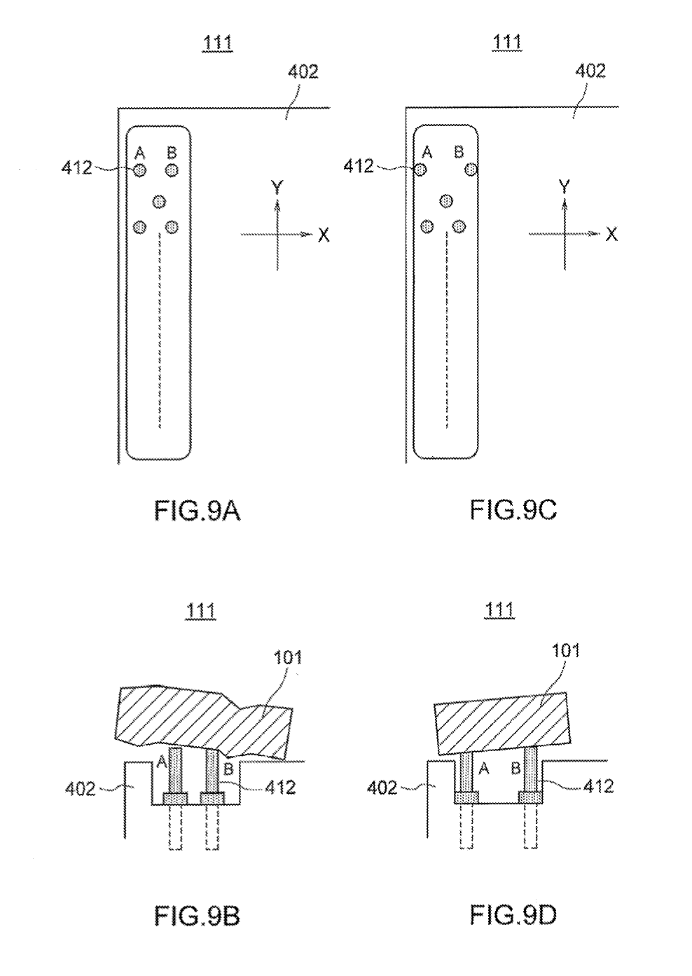

FIGS. 9A, 9B, 9C, and 9D are top views and side sectional views showing the second body 402 whose pins 412 move vertically and laterally.

FIGS. 9A and 98 a top view and a side sectional view showing the positions of the pins 412 in a normal state, respectively. Meanwhile, FIGS. 9C and 9D are a top view and a side sectional view showing a state in which the pins 412 move vertically and laterally from the positions in the normal state, respectively.

As shown in FIGS. 9A to 9D, the pins 412 of the present embodiment are configured to be movable vertically and laterally. FIGS. 9B and 9D show a state in which the distortion of the template 101 is eliminated by such a movement of the pins 412.

In FIGS. 9A to 9D, although the movement of the pins 412 of the second body 402 is described, the same holds for the movement of the pins 411 of the first body 401.

Hereinafter, referring again to FIG. 2, a control method for correcting the distortion of the template 101 and a positional deviation of the pattern on the template 101 will be described.

FIG. 2 shows the template substrate 301 and the pattern face 302 forming the template 101, the alignment mark 303 provided on the template substrate 301, and the alignment mark 304 provided on the pattern face 302.

The distortion of the template 101 can be detected by measuring the position of the alignment mark 303 of the template substrate 301. Also, the positional deviation of the pattern on the template 101 can be detected by measuring the positions of the alignment marks 303 and 304 of the template substrate 301 and the pattern face 302.

Accordingly, in the nanoimprint apparatus of the present embodiment, the positions of the alignment marks 303 and 304 are measured before starting the nanoimprint processing, whereby information about the distortion of the template 101 and the positional deviation of the pattern on the template 101 are previously obtained.

Further, a controller (e.g., a processor) in the nanoimprint apparatus previously calculates a control parameter for correcting the distortion of the template 101 and the positional deviation of the pattern on the template 101 by using the above information. The calculated control parameter is previously stored in a storage (e.g., a flash memory) in the nanoimprint apparatus.

Therefore, in the present embodiment, the distortion of the template 101 and the positional deviation of the pattern on the template 101 can be corrected with high accuracy by using the control parameter when performing the nanoimprint processing.

Examples of the control parameter include the magnitude of the stress applied to the template 101 by the deformation controller 404, the positions and the pressure of the pins 411 and 412, the temperature of the template chuck 111, and the temperature of the template 101.. One or more of those control parameters can be used in the present embodiment, for example.

As described above, in the present embodiment, the template chuck 111 sandwiches the template 101 vertically between the first and second bodies 401 and 402 to hold the template 101. Further, the deformation controller 404 applies the stress to the side surfaces of the template 101 through the contact members 403 to control the deformation of the template 101. Consequently, in the present embodiment, the holding and the deformation control of templates 101 having various thicknesses, formed of various materials, and having various shapes can be realized.

Further, in the present embodiment, the first body 401, the second body 402, and each of the contact members 403 are configured to be movable individually. According to such structure, the holding and the deformation control of the templates 101 having various thicknesses, formed of various materials, and having various shapes can be easily realized by driving those components individually.

Further, in the present embodiment, the first and second bodies 401 and 402 are configured to contact the upper surface S₁ and the lower surface S₂ of the template 101 through the pins 411 and 412, respectively. Consequently, in the present embodiment, the vertical pressure as well as the lateral stress can be applied to the template 101.

Hereinafter, second and third embodiments as variations of the first embodiment will be described. For the second and third embodiments, the differences from the first embodiment will be mainly described.

### Second Embodiment

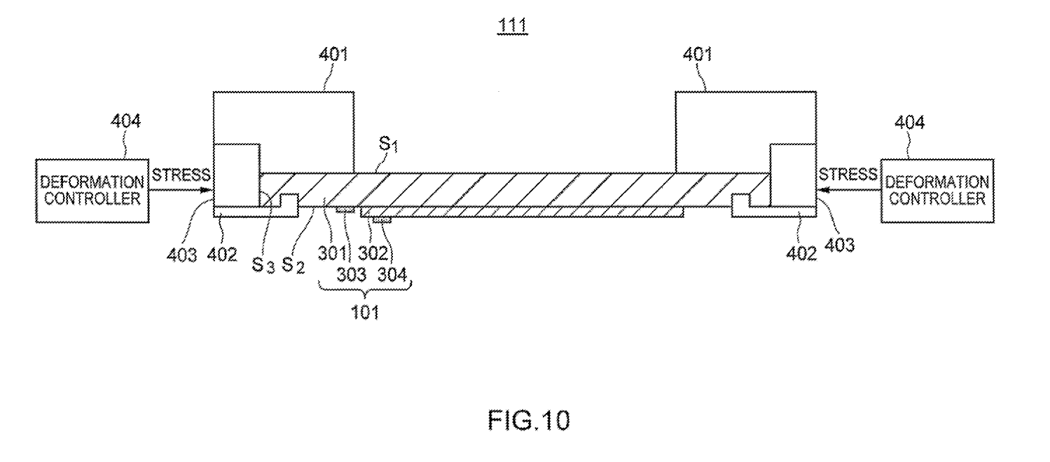

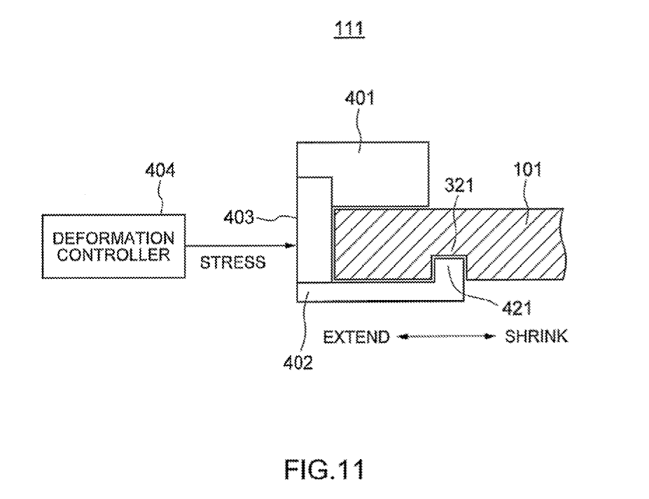

FIGS. 10 and 11 are side sectional views showing a structure of a template chuck 111 of a second embodiment. FIG. 11 is an enlarged side sectional view of the template chuck 111 of FIG. 10.

In the present embodiment, the first and second bodies 401 and 402 do not have the pins 411 and 412. The first and second bodies 401 and 402 are configured to contact the upper surface S₁ and the lower surface S₂ of the template 101 in surface contact, respectively (FIGS. 10 and 11).

As shown in FIG. 11, the template 101 of the present embodiment has a recess 321 provided on the lower surface S₂. Also, the second body 402 has a protrusion 421 provided on its upper surface, and to be inserted in the recess 321 of the template 101. Conversely, the template 101 of the present embodiment has the recess 321 in which the protrusion 421 of the second body 402 is to be inserted.

In addition, the second body 402 is configured to be movable both vertically and laterally (FIG. 11). Therefore, in the present embodiment, the deformation of the template 101 can be controlled by driving the second body 402 laterally, as well as applying the stress by the deformation controller 404.

In the present embodiment, as shown in FIG. 11, the second body 402 can be driven outward, whereby the template 101 can be deformed in a direction of extending the template 101. On the other hand, the second body 402 is driven inward, whereby the template 101 can be deformed in a direction of shrinking the template 101.

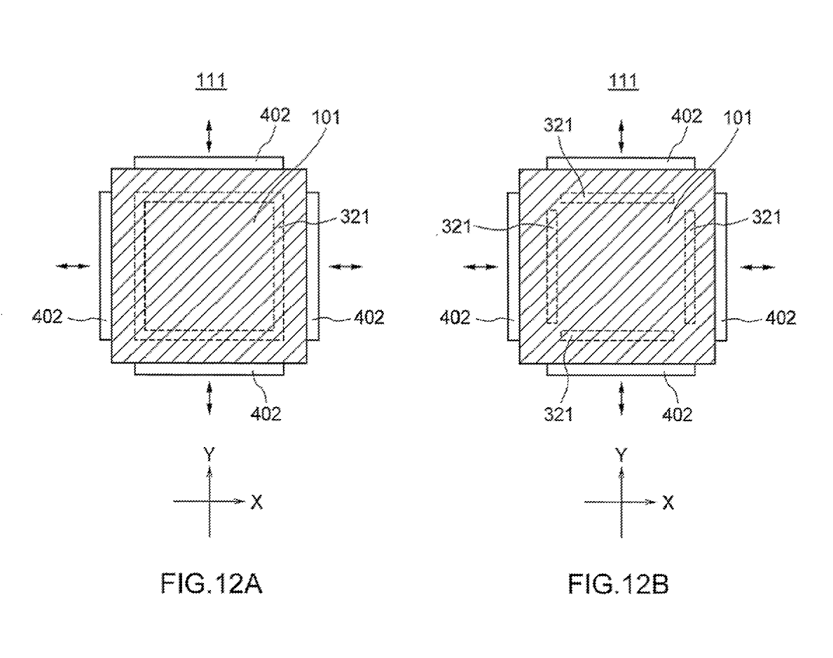

FIGS. 12A and 12B are top views showing examples of the shape of the recess 312 of the template 101 shown in FIG. 10.

FIGS. 12A and 12B show examples of the planar shape of the recess 321 in which protrusions 421 of four second bodies 402 are to be inserted. The template 101 of FIG. 12A has a single annular recess 321 for the protrusions 421. On the other hand, the template 101 of FIG. 12B has four recesses 321 for the protrusions 421. In the present embodiment, the recesses 321 of any of FIGS. 12A and 12B may be used.

As described above, in the present embodiment, the first and second bodies 401 and 402 are configured to contact the upper surface S₁ and the lower surface S₂ of the template 101 in surface contact, respectively. Further, the second body 402 has the protrusion 421 provided on its upper surface, and to be inserted in the recess 321 on the lower surface S₂ of the template 101. Therefore, in the present embodiment, the deformation of the template 101 can be controlled by driving the second body 402 laterally, as well as applying the stress by the deformation controller 404.

### Third Embodiment

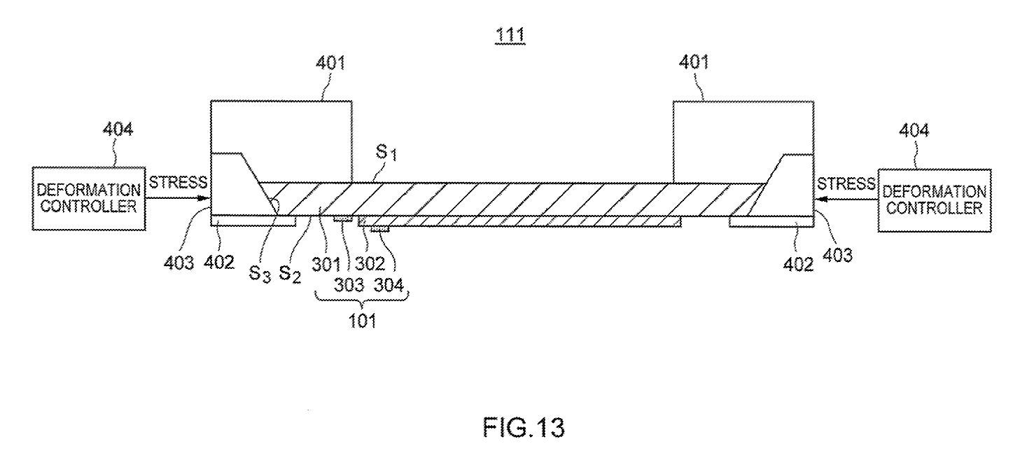

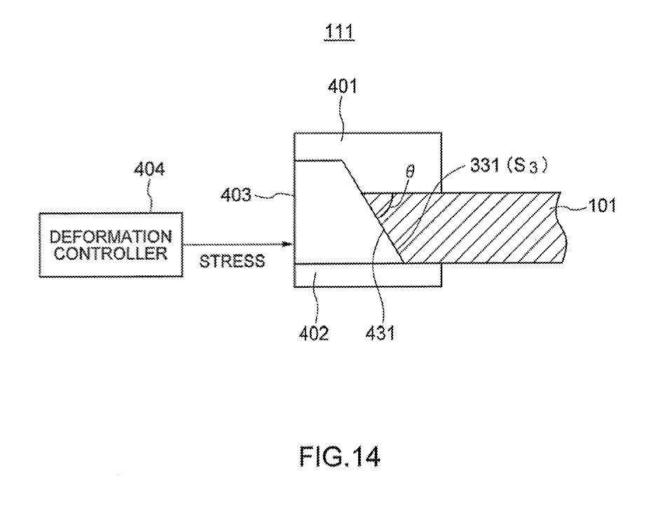

FIGS. 13 and 14 are side sectional views showing a structure of a template chuck 111 of a third embodiment. FIG. 14 is an enlarged side sectional view of the template chuck 111 of FIG. 13.

In the present embodiment, similarly to the second embodiment, the first and second bodies 401 and 402 do not have the pins 411 and 412. The first and second bodies 401 and 402 are configured to contact the upper surface S₁ and the lower surface S₂ of the template 101 in surface contact, respectively (FIGS. 13 and 14).

In the present embodiment, as shown in FIG. 14, the side surfaces 331 (S₃) of the template 101 and the side surfaces 431 of the contact members 403 have tapered shapes adapted to each other. In other words, the side surfaces 331 of the template 101 and the side surfaces 431 of the contact members 403 are taper surfaces having the same inclination angle.

Therefore, in the present embodiment, the contact areas between the template 101 and the contact members 403 are larger than those in the case where there is no taper. This enables the deformation controller 404 and the contact members 403 to easily hold the template 101 and easily apply the stress to the template 101.

In FIG. 14, the angle of the side surfaces S₃ to the upper surface S₁ of the template 101 is denoted by θ. In the present embodiment, the angle θ is set within a range of 30 to 60 degrees, for example, about 45 degrees. The value of the angle θ may be common to all the side surfaces S₃, or may be different for each of the side surfaces S₃. In the latter case, only some side surfaces S₃ may have tapered shapes.

As described above, in the present embodiment, the first and second bodies 401 and 402 are configured to contact the upper surface S₁ and the lower surface S₂ of the template 101 in surface contact, respectively. Further, the side surfaces 331 of the template 101 and the side surfaces 431 of the contact members 403 have tapered shapes.

Therefore, in the present embodiment, the contact areas between the template 101 and the contact members 403 are increased, so that the deformation controller 404 and the contact member 403 can easily hold the template 101, and can easily apply the stress to the template 101.

In the description of FIG. 1, although the resist material 202 is cured by the UV light, the resist material 202 may be cured by electromagnetic waves or heat other than the UV light.

Further, although various examples of the control parameter are shown in the first embodiment, the examples of the control parameter further include the size of the contact areas between the first and second bodies 401 and 402 and the template 101 of the second and third embodiments.

Further, a combination of two or more of the first to third embodiments may also be used. For example, the first and third embodiments may be combined as follows: the first and second bodies 401 and 402 have the pins 411 and 412, while the side surfaces 331 of the template 101 and the side surfaces 431 of the contact members 403 have tapered shapes.

While certain embodiments have been described, these embodiments have been presented by way of example only, and are not intended to limit the scope of the inventions. Indeed, the novel chucks, apparatuses and methods described herein may be embodied in a variety of other forms; furthermore, various omissions, substitutions and changes in the form of the chucks, apparatuses and methods described herein may be made without departing from the spirit of the inventions. The accompanying claims and their equivalents are intended to cover such forms or modifications as would fall within the scope and spirit of the inventions.

1. A template chuck for an imprint apparatus, the chuck comprising:
first and second bodies configured to contact an upper surface and a lower surface of a template, respectively, to sandwich the template vertically;
contact members configured to contact side surfaces of the template to sandwich the template laterally; and
a deformation controller configured to deform the template by applying a stress to the template through the contact members,
wherein the first body, the second body, and the contact members are configured to be movable individually.

2. The chuck of claim 1, wherein
he first body is configured to contact the upper surface of the template through a plurality of first pins, and
the second body is configured to contact the lower surface of the template through a plurality of second pins.

3. The chuck of claim 2, wherein
the plurality of first and second pins are configured to be movable vertically and laterally.

4. The chuck of claim 1, wherein
the first and second bodies are configured to contact the upper surface and the lower surface of the template in surface contact, respectively, and
the second body comprises a protrusion provided on an upper surface of the second body, and to be inserted in a recess on the lower surface of the template.

5. The chuck of claim 4, wherein
the second body is configured to be movable vertically and laterally.

6. The chuck of claim 5, wherein
the second body is configured to be movable in an extension direction of the template.

7. The chuck of claim 5, wherein
the second body is configured to be movable in a shrink direction of the template.

8. The chuck of claim 1, wherein
the first and second bodies are configured to contact the upper surface and the lower surface of the template in surface contact, respectively, and
side surfaces of the contact members and the side surfaces of the template have tapered shapes.

9. The chuck of claim 8, wherein
the side surfaces of the contact members and the side surfaces of the template have the same inclination angle.

10. The chuck of claim 8, wherein
inclination angles of the side surfaces of the contact members and the side surfaces of the template are 30 to 60 degrees.

11. The chuck of claim 1, wherein
the first body is an electrostatic chuck configured to attract the template with an electrostatic force, or a vacuum chuck configured to attract the template with vacuum.

12. The chuck of claim 1, wherein
the deformation controller comprises a piezoelectric device or an actuator configured to generate the stress.

13. An imprint apparatus comprising:
first and second bodies configured to contact an upper surface and a lower surface of a template, respectively, to sandwich the template vertically;
contact members configured to contact side surfaces of the template to sandwich the template laterally;
a deformation controller configured to deform the template by applying a stress to the template through the contact members; and
a light source configured to irradiate a resist material on a transfer target substrate with light while the template is in contact with the resist material, to cure the resist material,
wherein the first body, the second body, and the contact members are configured to be movable individually.

14. The apparatus of claim 13, wherein
the first body is configured to contact the upper surface of the template through a plurality of first pins, and
the second body is configured to contact the lower surface of the template through a plurality of second pins.

15. The apparatus of claim 13, wherein
the first and second bodies are configured to contact the upper surface and the lower surface of the template in surface contact, respectively, and
the second body comprises a protrusion provided on an upper surface of the second body, and to be inserted in a recess on the lower surface of the template.

16. The apparatus of claim 13, wherein
the first and second bodies are configured to contact the upper surface and the lower surface of the template in surface contact, respectively, and
side surfaces of the contact members and the side surfaces of the template have tapered shapes.

17. A pattern forming method comprising:
bringing first and second bodies into contact with an upper surface and a lower surface of a template, respectively, to sandwich the template vertically between the first and second bodies;
bringing contact members into contact with side surfaces of the template to sandwich the template laterally between the contact members;
deforming the template by applying a stress to the template through the contact members; and
curing a resist material on a transfer target substrate while the template is in contact with the resist material, to form a resist pattern on the transfer target substrate,
wherein the first body, the second body, and the contact members are configured to be movable individually.

18. The method of claim 17, wherein
the first body is configured to contact the upper surface of the template through a plurality of first pins, and
the second body is configured to contact the lower surface of the template through a plurality of second pins.

19. The method of claim 17, wherein
the first and second bodies are configured to contact the upper surface and the lower surface of the template in surface contact, respectively, and
the second body comprises a protrusion provided on an upper surface of the second body, and to be inserted in a recess on the lower surface of the template.

20. The method of claim 17, wherein
the first and second bodies are configured to contact the upper surface and the lower surface of the template in surface contact, respectively, and
side surfaces of the contact members and the side surfaces of the template have tapered shapes.
